(19) United States
(12) Patent Application Publication
(10) Pub. No.: US 2015/0358501 A1
(43) Pub. Date: Dec. 10, 2015

(54) APPARATUS, METHOD, AND STORAGE MEDIUM OF PROGRAM

(71) Applicant: Yoshihiro KAWASHIMA, Kanagawa (JP)

(72) Inventor: Yoshihiro KAWASHIMA, Kanagawa (JP)

(73) Assignee: RICOH COMPANY, LTD., Tokyo (JP)

(21) Appl. No.: 14/724,938

(22) Filed: May 29, 2015

(30) Foreign Application Priority Data
Jun. 9, 2014 (JP) 2014-118451

(51) Int. Cl. H04N 1/327; H04N 1/00

(52) U.S. Cl. CPC H04N 1/32795; H04N 1/00896; H04N 1/00904; H04N 2201/0094

(57) ABSTRACT

An apparatus communicable with an external apparatus using serial communication includes a communication interface connectable with the external apparatus, a first controller connectable with the communication interface, a second controller connectable with the communication interface, and a switching device to connect the communication interface with one of the first controller and the second controller depending on an operation mode of the apparatus. When a transition request to an energy-saving mode is detected while the first controller is connected with the communication interface, and the communication interface is connected with the external apparatus, the switching device switches a connection partner of the communication interface from the first controller to the second controller.

### CROSS-REFERENCE TO RELATED APPLICATION

This application claims priority pursuant to 35 U.S.C. §119(a) to Japanese Patent Application No. 2014-118451, filed on Jun. 9, 2014 in the Japan Patent Office, the disclosure of which are incorporated by reference herein in their entirety.

### BACKGROUND

1. Technical Field

The present invention relates to an apparatus that can communicate with an external apparatus using serial communication, and more particularly to an apparatus that can continuously communicate with an external apparatus using serial communication even when a power consumption mode is shifted from a normal mode to an energy-saving mode.

2. Background Art

Power-saving technologies to reduce power consumption of image forming apparatuses such as printers and multi-functional peripherals (MFPs) have been developed. For example, an electronic apparatus, which can communicate with an external apparatus such as a host, includes a system controller and a universal serial bus (USB) host device controller that can connect a card reader and a USB port disposed in the electronic apparatus. When the electronic apparatus shifts a power consumption mode to an energy-saving mode, the system controller and the USB host device controller connect the card reader and the USB port to communicate with the host connected to the USB port, in which power consumption of the electronic apparatus can be reduced under the energy-saving mode.

In this electronic apparatus, after shifting to the energy-saving mode, the card reader can communicate with the host via the USB port, but the system controller of the electronic apparatus cannot communicate with the host.

### SUMMARY

In one aspect of the present invention, an apparatus communicable with an external apparatus using serial communication is devised. The apparatus includes a communication interface connectable with the external apparatus, a first controller connectable with the communication interface, a second controller connectable with the communication interface, and a switching device to connect the communication interface with one of the first controller and the second controller depending on an operation mode of the apparatus. When a transition request to an energy-saving mode is detected while the first controller is connected with the communication interface, and the communication interface is connected with the external apparatus, the switching device switches a connection partner of the communication interface from the first controller to the second controller.

In another aspect of the present invention, a method of executing a serial communication between an apparatus and an external apparatus is devised. The apparatus includes a communication interface connectable with the external apparatus, a first controller connectable with the communication interface, and a second controller connectable with the communication interface. The method includes the steps of shutting down a communication between the communication interface and the external apparatus when a transition request to an energy-saving mode is received by the first controller while the first controller is connected with the communication interface, and the communication interface is connected with the external apparatus, switching a connection partner of the communication interface from the first controller to the second controller, and establishing a communication between the communication interface and the external apparatus when the second controller is connected to the communication interface by the switching step.

In another aspect of the present invention, a non-transitory storage medium storing a program that, when executed by a computer, causes the computer to execute a method of executing a serial communication between an apparatus and an external apparatus is devised. The apparatus includes a communication interface connectable with the external apparatus, a first controller connectable with the communication interface, and a second controller connectable with the communication interface. The method includes the steps of shutting down a communication between the communication interface and the external apparatus when a transition request to an energy-saving mode is received by the first controller while the first controller is connected with the communication interface, and the communication interface is connected with the external apparatus, switching a connection partner of the communication interface from the first controller to the second controller, and establishing a communication between the communication interface and the external apparatus when the second controller is connected to the communication interface by the switching step.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a hardware configuration of an image forming apparatus according to one or more example embodiments;

FIG. 2 is a functional configuration of the image forming apparatus of FIG. 1 when the image forming apparatus executes a program according to one or more example embodiments;

FIG. 3 is a flowchart showing the steps of a process of executable by the image forming apparatus of FIG. 1;

FIG. 4 is an example of a table including connection partner system on chips (SOCs), switch (SW) control signals, and differential signal lines used for each of operation modes; and

FIG. 5 is an example of a setting screen useable for setting information.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more example embodiments are described hereinafter.

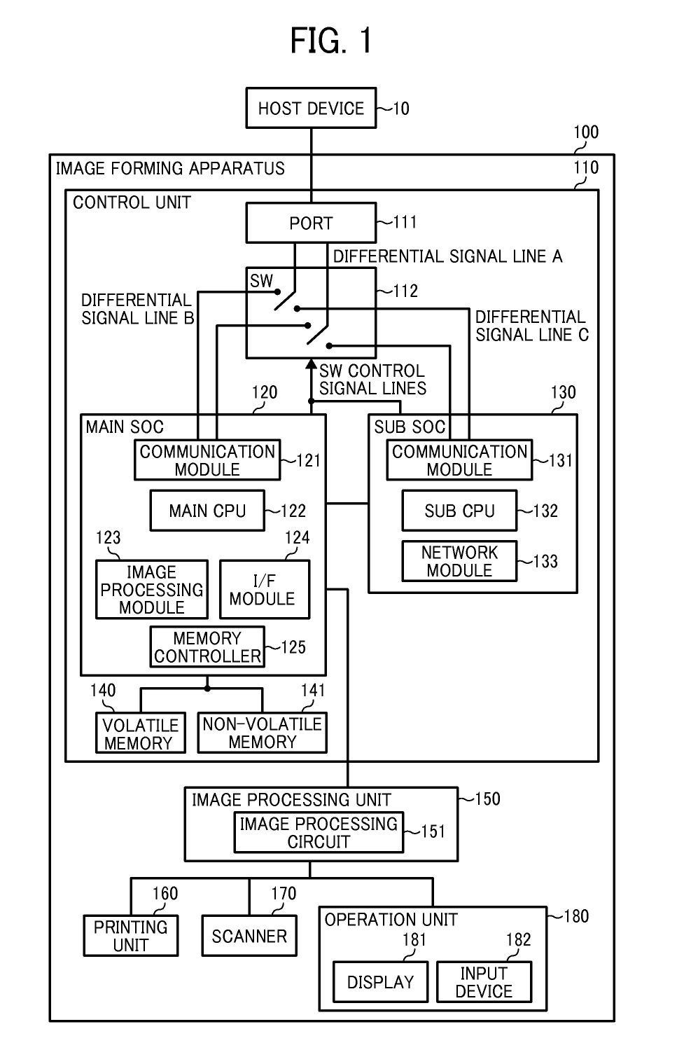

FIG. 1 is a hardware configuration of an image forming apparatus 100 according to one or more example embodiments. A description is given of a hardware configuration of the image forming apparatus 100 with reference to FIG. 1.

The image forming apparatus 100 is an example of apparatuses that can perform serial communication with external apparatuses such as a host device 10. The image forming apparatus 100 includes, for example, a control unit 110, an image processing unit 150, a printing unit 160, a scanner 170, and an operation unit 180.

The control unit 110, which controls operations of the image forming apparatus 100, includes, for example, a port 111, a switch (SW) 112, a main system on chip (SOC) 120, a sub system on chip (SOC) 130, a volatile memory 140, and a non-volatile memory 141.

The port 111 is, for example, a serial communication interface compatible to universal serial bus (USB). The port 111 can be connected to the host device 10 via a serial communication compatible cable such as a USB cable. Further, the port 111 be connected to the SW 112 via two differential signal lines A that can be used to transmit differential signals. In this description, the port 111 employs, for example, a serial communication compatible port such as a USB port.

The SW 112 is a switching device that can switch the SOCs connected to the host device 10 based on SW control signals supplied from the main SOC 120 and the sub SOC 130. The SW 112 can switch differential signal lines connected to the differential signal lines A to switch a SOC that can communicate with the host device 10. As to the configuration of FIG. 1, two differential signal lines B are connected to the main SOC 120, and two differential signal lines C are connected to the sub SOC 130.

The image forming apparatus 100 can be operated under one or more operation modes such as a normal mode, and energy-saving mode. Specifically, when the image forming apparatus 100 is operated under the normal mode, the differential signal lines A and the differential signal lines B are connected, with which the host device 10 and the main SOC 120 can communicate with each other. Further, when the image forming apparatus 100 is operated under the energy-saving mode, the differential signal lines A and the differential signal lines C are connected, with which the host device 10 and the sub SOC 130 can communicate with each other.

The main SOC 120 (first controller) controls and performs processing during the normal mode. The main SOC 120 includes, for example, a communication module 121, a main central processing unit (CPU) 122, an image processing module 123, an interface (I/F) module 124, and a memory controller 125.

Under the control of the main CPU 122, the communication module 121 performs a communication with the host device 10 connected to the port 111.

The main CPU 122 is a processor or a circuit that can execute a program for controlling operations of the image forming apparatus 100 during the normal mode (hereinafter, a normal mode execution program). The image processing module 123 controls the image processing unit 150 to perform image processing. The I/F module 124 controls a communication between the main SOC 120 and the image processing unit 150. The memory controller 125 controls the volatile memory 140 and the non-volatile memory 141.

The non-volatile memory 141 is a non-volatile storage device such as a read only memory (ROM), and a hard disk drive (HDD) that stores the normal mode execution program and various data. The volatile memory 140 is a volatile storage device such as a random access memory (RAM) that provides a working area of programs executable by the image forming apparatus 100.

Under the control of operating system (OS) of the image forming apparatus 100, the main CPU 122 reads programs from the non-volatile memory 141, loads the programs on the volatile memory 140, and executes the programs to devise various functions to be described later.

The sub SOC 130 (second controller) controls and performs processing during the energy-saving mode. The sub SOC 130 includes, for example, a communication module 131, a sub central processing unit (CPU) 132, and a network module 133. As to the one or more example embodiments, power consumption of the sub SOC 130 is smaller than power consumption of the main SOC 120.

Under the control of the sub CPU 132, the communication module 131 performs a communication with the host device 10 connected to the port 111.

The sub CPU 132 is a processor or a circuit that can execute a program for controlling operations of the image forming apparatus 100 during the energy-saving mode (hereinafter, energy-saving mode execution program). The sub CPU 132 executes the energy-saving mode execution program stored in a memory or a storage device of the sub CPU 132.

The network module 133 controls a network communication. The network module 133 controls various communications (e.g., LAN, wireless communication) other than communications via the port 111.

The image processing unit 150 includes an image processing circuit 151 that can perform various image processing under the control of the image processing module 123. For example, the image processing unit 150 can be used to draw an image, and to instruct the printing unit 160 to print the image. Further, the image processing unit 150 provides image data generated by a scanning operation of the scanner 170 to the control unit 110. Further, the image processing unit 150 controls a screen image displayed on the operation unit 180.

The printing unit 160 can be used as an apparatus that prints images generated by the image processing unit 150 on print media. The scanner 170 can be used to scan document to generate image data.

The operation unit 180 can be used to receive an instruction of a user. The operation unit 180 includes, for example, a display 181, and an input device 182. The display 181 can display various screens such as an operation screen, and an information setting screen. The input device 182 is, for example, a touch panel, various buttons, a keyboard, a mouse or the like.

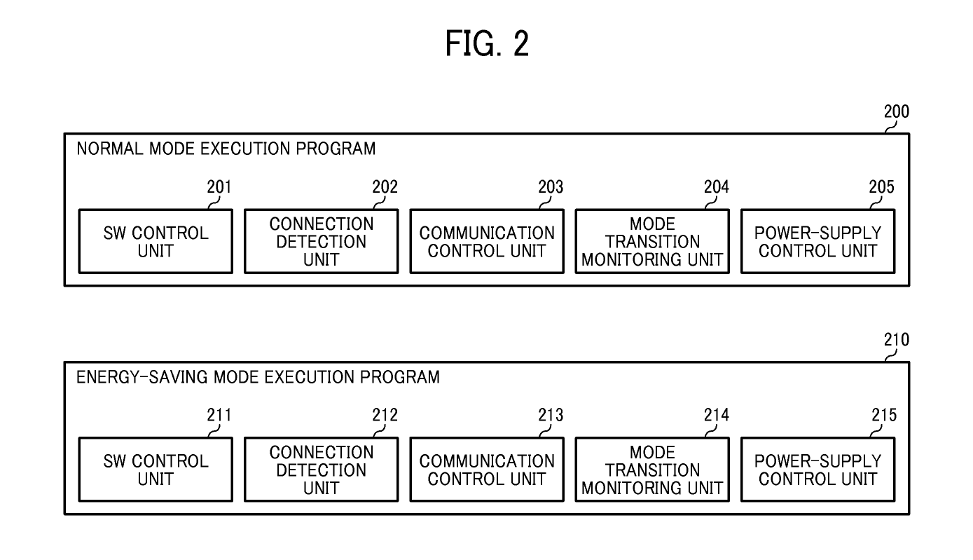

FIG. 2 is a functional configuration of the image forming apparatus 100 when the image forming apparatus 100 executes one or more programs according to one or more example embodiments. A description is given of two programs such as a normal mode execution program 200, and an energy-saving mode execution program 210 executable by the image forming apparatus 100 with reference to FIG. 2, in which the normal mode execution program 200 is executable by the main SOC 120 of the image forming apparatus 100, and the energy-saving mode execution program 210 is executable by the sub SOC 130 of the image forming apparatus 100.

The normal mode execution program 200 is executable by the main CPU 122 of the main SOC 120 during the normal mode. The normal mode execution program 200 includes, for example, a SW control unit 201, a connection detection unit 202, a communication control unit 203, a mode transition monitoring unit 204, and a power-supply control unit 205.

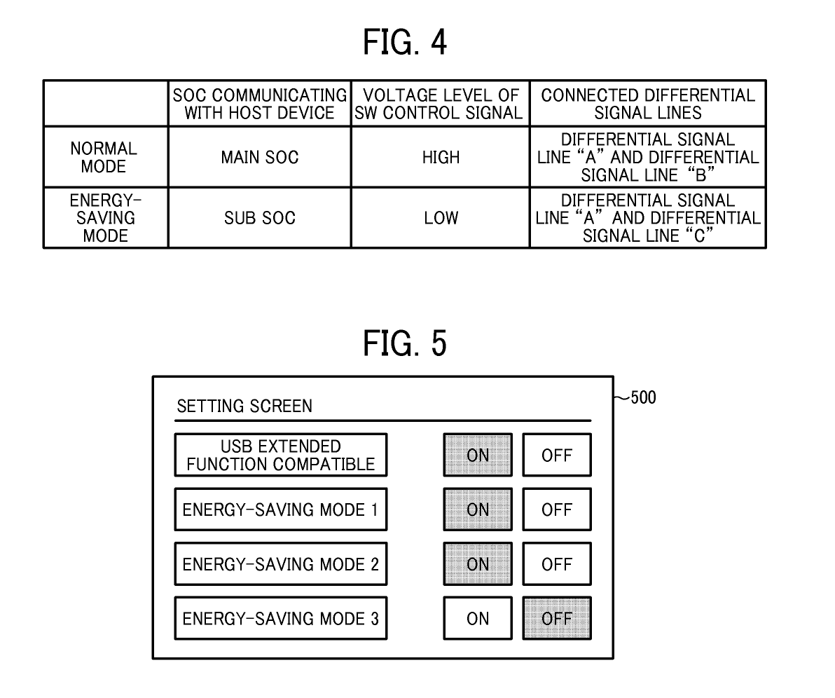

The SW control unit 201 can be used as a switching control unit that controls the SW 112 using a SW control signal. Based on settings information used for the SW control, the SW control unit 201 transmits a SW control signal from the main SOC 120 to the SW 112. FIG. 4 is an example of a table including connection partner SOCs, SW control signals, and differential signal lines used for each of operation modes. As to the settings information of the SW control, the SW control unit 201 transmits a SW control signal of high voltage level for the normal mode, and the SW control unit 201 transmits a SW control signal of low voltage level for the energy-saving mode.

The connection detection unit 202 can be used to detect a connection between the port 111 and the host device 10. The communication control unit 203 (first communication control unit) can be used to control the communication module 121 to control a communication via the port 111. When the host device 10 is connected to the port 111, the communication control unit 203 transmits communication connection information and a connection request to the host device 10 so as to establish a communication with the host device 10, in which the communication connection information and the connection request are required to establish the communication with the host device 10.

The mode transition monitoring unit 204 can be used to monitor a mode transition request. The mode transition monitoring unit 204 monitors whether a mode transition request is issued or detected, wherein the mode transition request includes a transition request to the energy-saving mode, and a transition request to the normal mode. When the mode transition monitoring unit 204 receives or detects the mode transition request, the mode transition monitoring unit 204 instructs the power-supply control unit 205 to supply power matched to a type of the mode transition request.

The power-supply control unit 205 can be used to control power supply to one or more devices disposed in the image forming apparatus 100. Based on an instruction from the mode transition monitoring unit 204, the power-supply control unit 205 controls a power supply unit that can supply power to the one or more devices disposed in the image forming apparatus 100, and controls a power supply operation or a power stop operation to the one or more devices.

Specifically, during the normal mode, power can be supplied to the one or more devices disposed in the image forming apparatus 100 except the sub CPU 132 of the sub SOC 130. During the energy-saving mode, power can be supplied only to the sub SOC 130, the port 111, and the SW 112.

The energy-saving mode execution program 210 is executable by the sub CPU 132 of the sub SOC 130 during the energy-saving mode. The energy-saving mode execution program 210 includes, for example, a SW control unit 211, a connection detection unit 212, a communication control unit 213, a mode transition monitoring unit 214, and a power-supply control unit 215.

The SW control unit 211 can be used as a switching control unit that controls the SW 112 using a SW control signal. The connection detection unit 212 can be used to detect a connection between the port 111 and the host device 10. The communication control unit 213 (second communication control unit) can be used to control the communication module 121 to control a communication via the port 111. The mode transition monitoring unit 214 can be used to monitor the mode transition request. The power-supply control unit 215 can be used to control power supply to the one or more devices disposed in the image forming apparatus 100.

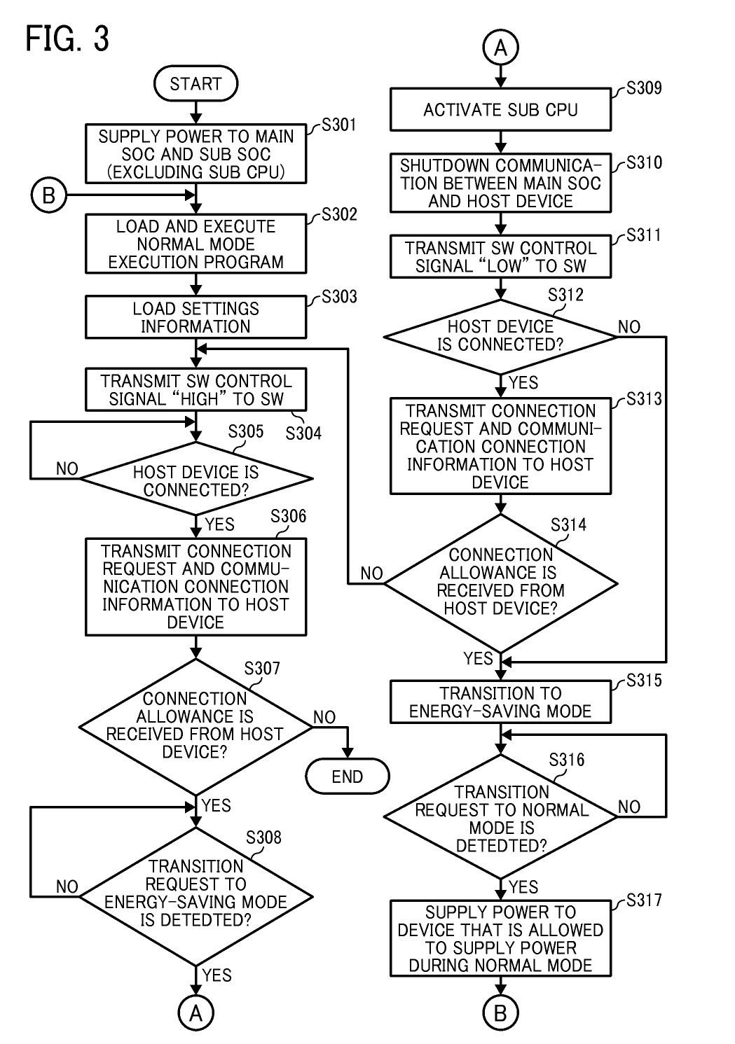

A description is given of a process executable by the image forming apparatus 100 with reference to FIG. 3. FIG. 3 is a flowchart showing the steps of a process of executable by the image forming apparatus 100.

The process of FIG. 3 can be started, for example, when power is supplied to the image forming apparatus 100. At step S301, the power supply unit of the image forming apparatus 100 supplies power to the main SOC 120, and the sub SOC 130. In the one or more example embodiments, when the image forming apparatus 100 is activated, power is not supplied to the sub CPU 132 of the sub SOC 130, and thereby the sub CPU 132 is not activated (i.e., the sub CPU 132 is at a sleep mode).

At step S302, the main CPU 122 reads the normal mode execution program 200 from the non-volatile memory 141, and loads and executes the normal mode execution program 200 on the volatile memory 140 to perform step S303 and subsequent steps.

At step S303, the SW control unit 201 of the normal mode execution program 200 acquires settings information such as SW control setting information and power-supply destination setting information from the non-volatile memory 141, and loads the settings information on the volatile memory 140.

At step S304, based on the SW control setting information, the SW control unit 201 instructs a transmission of a SW control signal from the main SOC 120 to the SW 112.

Specifically, based on the SW control setting information, the SW control unit 201 instructs a transmission of a SW control signal of high voltage level. Based on the SW control signal of high voltage level, the SW 112 connects the differential signal lines A and the differential signal lines B, with which the main SOC 120 and the port 111 can be connected.

At step S305, the connection detection unit 202 determines whether the host device 10 is connected to the port 111. If the host device 10 is not connected to the port 111 (S305: NO), the process at step S305 is repeated. By contrast, if the host device 10 is connected to the port 111 (S305: YES), the sequence proceeds to step S306.

At step S306, the communication control unit 203 transmits a connection request and communication connection information to the host device 10. At step S307, the communication control unit 203 determines whether a connection allowance is received from the host device 10. If the connection allowance is not received from the host device 10 (S307: NO), the sequence is completed. By contrast, if the connection allowance is received from the host device 10 (S307: YES), the sequence proceeds to step S308.

At step S308, the mode transition monitoring unit 204 determines whether a transition request to the energy-saving mode is received or detected. If the transition request to the energy-saving mode is not received or detected (S308: NO), the process at step S308 is repeated. By contrast, if the transition request to the energy-saving mode is received or detected (S308: YES), the sequence proceeds to step S309.

At step S309, the power-supply control unit 205 instructs the power supply unit to supply power to the sub CPU 132 to activate the sub CPU 132. At step S310, the communication control unit 203 shutdowns a communication between the main SOC 120 and the host device 10. At step S311, based on the SW control setting information, the SW control unit 211 of the energy-saving mode execution program 210 instructs a transmission of a SW control signal (Low) from the sub SOC 130 to the SW 112. Based on the SW control signal (Low), the SW 112 connects the differential signal lines A and the differential signal lines C, with which the sub SOC 130 and the port 111 can be connected.

At step S312, the connection detection unit 212 determines whether the host device 10 is connected to the port 111. If the host device 10 is not connected to the port 111 (S312: NO), the sequence proceeds to step S315. By contrast, if the host device 10 is connected to the port 111 (S312: YES), the sequence proceeds to step S313.

At step S313, the communication control unit 213 transmits a connection request and a communication connection information to the host device 10. At step S314, the communication control unit 213 determines whether the communication control unit 213 receives a connection allowance from the host device 10. If the connection allowance is not received from the host device 10 (S314: NO), the sequence proceeds to step S304. By contrast, if the connection allowance is received from the host device 10 (S314: YES), which means when a communication with the host device 10 is established, the sequence proceeds to step S315.

At step S315, based on the power-supply destination setting information, the power-supply control unit 215 supplies power only to one or more devices designated by the power-supply destination setting information, and then an operation mode shifts from the normal mode to the energy-saving mode (i.e., transition from the normal mode to the energy-saving mode). At step S316, the mode transition monitoring unit 214 determines whether a transition request to the normal mode is received or detected. If the transition request to the normal mode is not received or detected (S316: NO), the process at step S316 is repeated. By contrast, if the transition request to the normal mode is received or detected (S316: YES), the sequence proceeds to step S317.

At step S317, the power-supply control unit 215 supplies power to one or more devices (i.e., devices other than the sub CPU 132), which are allowed for power supply during the normal mode, and then the sequence returns to step S302.

As to the above configuration, the energy-saving mode employs one mode, but the energy-saving mode can employ a plurality of energy-saving modes in another configuration, in which when the transition request to each of the energy-saving modes is received or detected, the SOC connected to the host device 10 is switched, and power is supplied to the one or more devices, which are allowed for power supply. A description is given of another configuration having a plurality of energy-saving modes with reference to FIG. 5.

FIG. 5 is an example of a screen used for setting information. A user can set settings information by using a setting screen 500 displayed on the display 181. The setting screen 500 includes, for example, a USB extended function compatible, an energy-saving mode 1, an energy-saving mode 2, and an energy-saving mode 3. In this configuration, when the “USB extended function compatible” is set ON, SW control setting information, which instructs a switching of the SW 112 when shifting the operation mode to the energy-saving mode, is generated. Specifically, the SW control setting information instructs a transmission of a SW control signal (Low) when shifting the operation mode to the energy-saving mode.

The energy-saving modes 1, 2, and 3 are the energy-saving modes that can be selected by a user. One or more devices to be supplied with power can be designated or assigned to each of the energy-saving modes 1, 2, and 3. Power-supply destination information correlating identification information of the energy-saving mode, and identification information of a device designated as a power-supply destination can be stored in the volatile memory 140.

As illustrated in FIG. 5, when the energy-saving modes 1 and 2 are set “ON,” power-supply destination information of the energy-saving mode 1, and power-supply destination information of the energy-saving mode 2 can be stored in the volatile memory 140. In this case, when a transition request to the energy-saving mode 1 is received or detected, power is supplied to one or more devices designated or correlated to the energy-saving mode 1, and further, when a transition request to the energy-saving mode 2 is received or detected, power is supplied to one or more devices designated or correlated to the energy-saving mode 2.

As to the above described apparatus, method, and program, even if the operation mode shifts or transits to the energy-saving mode, the controller or control device can still continuously communicate with an external apparatus while reducing power consumption required for the controller or control device being communicating with the external apparatus.

The computer software can be provided to the programmable device using any storage medium or carrier medium for storing processor-readable code such as a floppy disk, a compact disk read only memory (CD-ROM), a compact disk rewritable (CD-RW), a digital versatile disk read only memory (DVD-ROM), a DVD random access memory (DVD-RAM), DVD recording only/rewritable (DVD-R/RW), Blu-ray Disc (registered trademark), electrically erasable and programmable read only memory (EEPROM), erasable programmable read only memory (EPROM), a flash memory, a flexible disk, a memory card or stick such as USB memory, a memory chip, a secure digital (SD) card, a mini disk (MD), a magneto optical disc (MO), magnetic tape, a hard disk in a server, a solid state memory device or the like, but not limited these.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input apparatus, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C, C++, C#, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An apparatus communicable with an external apparatus using serial communication, the apparatus comprising:
a communication interface connectable with the external apparatus;
a first controller connectable with the communication interface;
a second controller connectable with the communication interface; and
a switching device to connect the communication interface with one of the first controller and the second controller depending on an operation mode of the apparatus,
wherein when a transition request to an energy-saving mode is detected while the first controller is connected with the communication interface, and the communication interface is connected with the external apparatus, the switching device switches a connection partner of the communication interface from the first controller to the second controller.

2. The apparatus of claim 1, wherein the first controller includes a first communication control unit, and a switching control unit, and the second controller includes a second communication control unit,
the first communication control unit shutdowns a communication between the first controller and the external apparatus when the transition request to the energy-saving mode is detected while the first controller is connected to the communication interface,
the switching control unit instructs the switching device to switch the connection partner of the communication interface from the first controller to the second controller when the transition request to the energy-saving mode is detected,
the second communication control unit establishes a communication between the second controller and the external apparatus when the second controller is connected to the communication interface.

3. The apparatus of claim 1, wherein when the apparatus shifts the operation mode to the energy-saving mode, power supply to the first controller is stopped.

4. The apparatus of claim 1, wherein power consumption of the second controller is smaller than power consumption of the first controller.

5. A method of executing a serial communication between an apparatus and an external apparatus, the apparatus including a communication interface connectable with the external apparatus, a first controller connectable with the communication interface, and a second controller connectable with the communication interface, the method comprising the steps of:
shutting down a communication between the communication interface and the external apparatus when a transition request to an energy-saving mode is detected by the first controller while the first controller is connected with the communication interface, and the communication interface is connected with the external apparatus;
switching a connection partner of the communication interface from the first controller to the second controller; and
establishing a communication between the communication interface and the external apparatus when the second controller is connected with the communication interface by the switching step.

6. The method of claim 5, further comprising the step of stopping power supply to the first controller when the apparatus shifts the operation mode to the energy-saving mode.

7. The method of claim 5, wherein power consumption of the second controller is smaller than power consumption of the first controller.

8. A non-transitory storage medium storing a program that, when executed by a computer, causes the computer to execute a method of executing a serial communication between an apparatus and an external apparatus, the apparatus including a communication interface connectable with the external apparatus, a first controller connectable with the communication interface, and a second controller connectable with the communication interface, the method comprising the steps of:
shutting down a communication between the communication interface and the external apparatus when a transition request to an energy-saving mode is detected by the first controller while the first controller is connected with the communication interface, and the communication interface is connected with the external apparatus;
switching a connection partner of the communication interface from the first controller to the second controller; and
establishing a communication between the communication interface and the external apparatus when the second controller is connected with the communication interface by the switching step.

9. The non-transitory storage medium of claim 8, wherein the method further comprising the step of stopping power supply to the first controller when the apparatus shifts the operation mode to the energy-saving mode.

10. The non-transitory storage medium of claim 8, wherein power consumption of the second controller is smaller than power consumption of the first controller.
